(19) United States
(12) Patent Application Publication
(10) Pub. No.: US 2026/0111095 A1
(43) Pub. Date: Apr. 23, 2026

(54) METHOD FOR CONTROLLING AN EXTENDED SCREEN COMPONENT, COMPUTER DEVICE, AND STORAGE MEDIUM

(71) Applicant: META-BOUNDS INC., Zhuhai (CN)

(72) Inventors: Jiahao YE, Zhuhai (CN); Yiran HUANG, Zhuhai (CN)

(21) Appl. No.: 19/424,184

(22) Filed: Dec. 18, 2025

Related U.S. Application Data
(63) Continuation of application No. PCT/CN2024/097090, filed on Jun. 3, 2024.

(30) Foreign Application Priority Data
Sep. 27, 2023 (CN) 2023112616808

(51) Int. Cl. G06F 3/04815; G06F 3/01; G06F 3/14

(52) U.S. Cl. CPC G06F 3/04815; G06F 3/011; G06F 3/017; G06F 3/14

(57) ABSTRACT

A method for controlling an extended screen component is provided. In the present disclosure, a movement selection pointer is obtained based on two key points of the user's hand, the intersection between the movement selection pointer and the extended screen component is then obtained when the user moves the hand, and the extended screen component that intersects with the movement selection pointer is used as a target component.

### CROSS-REFERENCE TO RELATED APPLICATIONS

This application is a National Stage of International Application No. PCT/CN2024/097090, filed on Jun. 3, 2024, which claims the priority of the Chinese Patent Application No.2023112616808 entitled “METHOD FOR CONTROLLING AN EXTENDED SCREEN COMPONENT, COMPUTER DEVICE, AND STORAGE MEDIUM” filed with the China National Intellectual Property Administration on Sep. 27, 2023, the entire contents of which are incorporated herein by reference.

### TECHNICAL FIELD

The present disclosure relates to the field of smart wearable technologies, and in particular, to a method for controlling an extended screen component, a computer device, and a storage medium.

### BACKGROUND

At present, although there are already some extended screen products for smart glasses (such as AR [Augmented Reality] glasses) and user devices (such as mobile phones, tablet computers, etc.) on the market, most operations on the extended screen of the user device use gestures, voice, or similar methods, which requires users to spend time learning and adapting to the operation modes. Moreover, when the user's gesture movements are not clear enough or the language is not clear enough, the identified extended screen may not be the one the user needs, resulting in low accuracy in extended screen selection. Therefore, how to improve the portability and accuracy of the user's selection of the extended screen has become an urgent problem to be solved.

### SUMMARY OF THE INVENTION

In a first aspect, the present disclosure provides a method for controlling an extended screen component, the method including:
identifying a screen outline of a user device to activate a screen extension mode;
based on a relative positional relationship between each extended screen component and the screen outline, displaying the extended screen component and a screen of the user device in a display interface;
based on a preset algorithm, tracking the coordinates of a first key point and the coordinates of a second key point of a user's hand in the display interface to generate a movement selection pointer; and
when the movement of the user's hand is detected, determining the extended screen component that intersects with the movement selection pointer as a target component, so as to control the target component.

In a second aspect, the present disclosure also provides a computer device, and the computer equipment includes a memory and a processor; the memory is configured to store a computer program; the processor is configured to execute the computer program, and perform the above-mentioned method for controlling the extended screen component when executing the computer program.

In a third aspect, the present disclosure also provides a computer-readable storage medium storing a computer program that, when executed by a processor, causes the processor to perform the above-mentioned method for controlling an extended screen component.

### BRIEF DESCRIPTION OF THE DRAWINGS

In order to more clearly illustrate the technical solutions in the embodiments of the present disclosure, the following is a brief introduction to the drawings used in the description of the embodiments. Obviously, the drawings described below are some embodiments of the present disclosure. For those skilled in the art, other drawings can also be obtained based on these drawings without inventive efforts.

FIG. 1 is a schematic flow chart illustrating a first embodiment of a method for controlling an extended screen component according to an embodiment of the present disclosure.

FIG. 2 is a schematic diagram illustrating a display interface of a method for controlling an extended screen component according to an embodiment of the present disclosure.

FIG. 3 is a schematic diagram illustrating an effect of component adaptive changes in a method for controlling an extended screen component according to an embodiment of the present disclosure.

FIG. 4 is a schematic flow chart illustrating a second embodiment of a method for controlling an extended screen component according to an embodiment of the present disclosure.

FIG. 5 is a schematic flow chart illustrating a third embodiment of a method for controlling an extended screen component according to an embodiment of the present disclosure.

FIG. 6 is a schematic block diagram illustrating an apparatus for controlling an extended screen component according to an embodiment of the present disclosure.

FIG. 7 is a schematic structural block diagram illustrating a computer device according to an embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are part of the embodiments of the present disclosure, rather than all the embodiments. Based on the embodiments in the present disclosure, all other embodiments obtained by those skilled in the art without inventive efforts should fall within the protection scope of the present disclosure.

The flow charts shown in the accompanying drawings are illustrative, and do not necessarily include all contents and operations/steps, nor do they necessarily need to be executed in the order described. For example, some operations/steps can also be decomposed, combined, or partially merged, so the actual execution order may be changed according to actual circumstances.

It should be understood that terms used in the specification of the present disclosure are for the purpose of describing specific embodiments and are not intended to limit the present disclosure. As used in the specification and the appended claims of the present disclosure, singular forms “a”, “an” and “the” are intended to include the plural forms unless the context clearly indicates otherwise.

It should be further understood that the term “and/or” used in the specification and the appended claims of the present disclosure refers to any combination and all possible combinations of one or more of the associated listed items, and includes these combinations.

The present disclosure provides a method for controlling an extended screen component, a computer device, and a storage medium, so as to improve the portability of operation and the accuracy of extended screen selection.

The present disclosure discloses a method for controlling an extended screen component, a computer device, and a storage medium. The method includes: identifying a screen outline of a user device to activate a screen extension mode; based on a relative positional relationship between each extended screen component and the screen outline, displaying the extended screen component and a screen of the user device in a display interface; based on a preset algorithm, tracking the coordinates of a first key point and the coordinates of a second key point of a user's hand in the display interface to generate a movement selection pointer; and when detecting movement of the user's hand, determine the extended screen component that intersects with the movement selection pointer as a target component, so as to control the target component. The method obtains a movement selection pointer based on two key points of the user's hand, and then obtains the intersection between the movement selection pointer and the extended screen component when the user moves the hand, and takes the extended screen component that intersects with the movement selection pointer as a target component, which simplifies user operations and improves the portability and accuracy of the user's selection of the extended screen component.

Embodiments of the present disclosure provide a method for controlling an extended screen component, a computer device, and a storage medium. The method for controlling an extended screen component can be applied to a server, generating a movement selection pointer via hand key points to determine a target component, resulting in improving the portability and accuracy of the user's selection of the extended screen component. The server may be an independent server or a server cluster.

Some implementation modes of the present disclosure are described in detail below with reference to the accompanying drawings. In the case of no conflict, the following embodiments and the features in the embodiments can be combined with each other.

Referring to FIG. 1, FIG. 1 is a schematic flowchart of a first embodiment illustrating a method for controlling an extended screen component according to an embodiment of the present disclosure. The method for controlling an extended screen component can be applied to a server, and is configured to generate a movement selection pointer via hand keypoints to determine a target component, improving the portability and accuracy of the user's selection of the extended screen component.

As shown in FIG. 1, the method for controlling an extended screen component specifically includes steps S101 to S104.

S101: Identify a screen outline of a user device to activate a screen extension mode.

In one embodiment, when a screen of a user device (such as a mobile phone, a tablet computer, etc.) is turned on by a user, the screen brightness will change.

In a specific embodiment, when a smart wearable device (such as AR glasses, an AR helmet, etc.) detects that the screen of the user device is turned on, the smart wearable device invokes its own image acquisition module to identify the screen outline of the user device and activate the screen extension mode. It can be understood that the image acquisition module may be a camera built into the smart wearable device. In another embodiment, the image acquisition module may also be a camera connected to the smart wearable device.

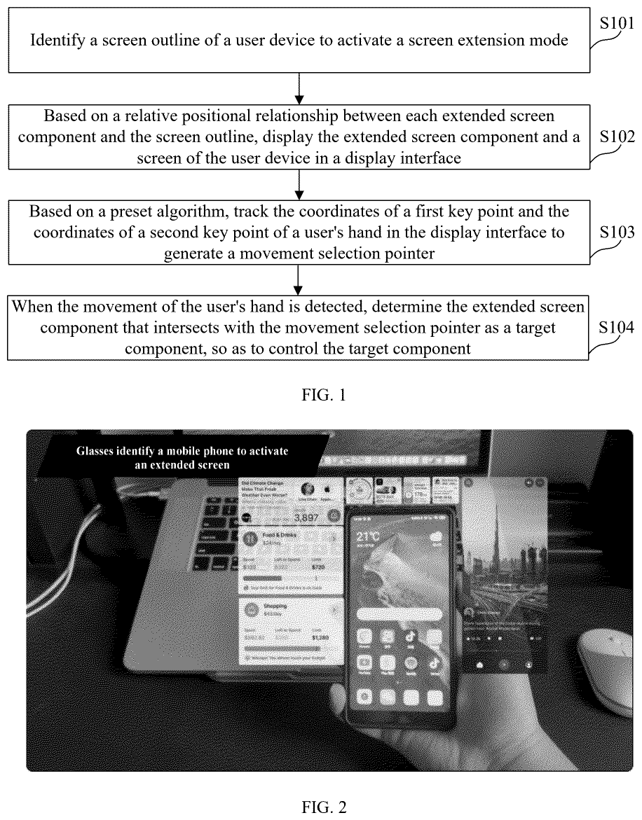

In one embodiment, as shown in FIG. 2, in the screen extension mode, the user device and the extended screen component are in a bound state. In a display interface presented to the user by the smart wearable device, the screen of the user device and the extended screen component of the user device or the smart wearable device are displayed.

It can be understood that the extended screen component may be an application component in the user device, which can display application content of the user device, such as a video component that can display a playing video.

In another embodiment, the extended screen component may also be a functional component in the smart wearable device, which can display relevant functions of the smart wearable device to facilitate the user's query and operation.

The extended screen component is a high-performance cross-terminal development framework for smart large-screen devices, and a fast application engine running on smart wearable devices, which can help developers quickly build application services for smart wearable devices and provide multi-screen interaction capabilities.

S102: Based on a relative positional relationship between each extended screen component and the screen outline, display the extended screen component and a screen of the user device in a display interface.

Before the based on a relative positional relationship between each extended screen component and the screen outline, displaying the method further includes: obtaining contour coordinates of the screen outline, and obtaining a first position of the user device in the display interface based on the contour coordinates; based on a preset size of each extended screen component, a screen size of the user device and the first position, obtaining the relative positional relationship between each extended screen component and the user device.

In one embodiment, the smart wearable device invokes the image acquisition module to identify the screen outline of the user device and record the contour coordinates of the screen outline of the user device. The coordinates of a top-left corner point and a bottom-right corner point of the screen of the user device are filtered out from the contour coordinates to represent the first position of the screen of the user device in the display interface. For example, after the user turns on the mobile phone screen, the AR glasses identify an screen outline of the mobile phone screen, and obtain the coordinates of the top-left corner point and the bottom-right corner point of the screen outline of the mobile phone to represent the first position of the screen of the mobile phone.

In one embodiment, a smart wearable device (such as smart glasses, etc.) projects and displays the screen content of the user device or the relevant content of the smart wearable device itself as AR content in the external space of the screen outline in the form of an extended screen component, forming an extended display of the screen of the user device.

In one embodiment, the display interface is an interface presented by the smart wearable device for the user to view, and is acquired by an image acquisition module of the smart wearable device. It can be understood that when an image acquired by the image acquisition module is not cropped, a size of the image acquired by the image acquisition module is the same as a size of the display interface. The size of the image can be calculated based on a preset image resolution and a preset pixel value of an image acquisition apparatus. For example, when an image has a pixel value of 600×800 pixels and a resolution of 300×400, the actual length and width of the image are: 600/300=2 inches, 800/400=2 inches, and the length and width are both approximately 5 cm, that is, the image is actually 5 cm long and 5 cm wide. Coordinate information of the display interface can be obtained based on size information of the image acquired by the image acquisition module, and a coordinate system can be determined based on the size information of the image acquired by the image acquisition module. For example, when the image acquisition module is a camera device, when the width of the image acquired by the camera is known as and the height of the image is known as, the top-left corner point is used as the origin (0, 0) of the coordinate system, a left edge of the display interface is used as a vertical coordinate axis of the coordinate system, and a top edge of the display interface is used as a horizontal coordinate axis of the coordinate system, then the coordinates of the bottom-right corner point of the display interface can be obtained as (c_{w}, cₕ).

In one embodiment, the relative positional relationship between each extended screen component and the first position of the user device is determined based on the size of each extended screen component and the screen size of the user device. For example, the user device is a mobile phone with a screen size of 7.5 cm in width and 13.5 cm in length. The sizes of extended screen components are as follows: a first extended screen component has a size of 2 cm×2 cm, a second component has a size of 1.5 cm×1.5 cm, and a third component has a size of 1.5 cm×2 cm. Then, based on the width and length of the screen of the mobile phone, extended screen components of appropriate sizes can be arranged in rows at the top of the mobile phone and in columns on the sides of the mobile phone, so as to obtain the relative positional relationship of each extended screen component with respect to the screen of the mobile phone. For example, the first extended screen component is located in the first column and the second row on the left side of the screen of the mobile phone.

In one embodiment, position coordinates of each extended screen component are determined based on the relative positional relationship between each extended screen component and the first position of the user device, as well as the size of the extended screen component. For example, a top-left corner point of the user device is (20, 30) and a bottom-right corner point is (30, 50), then the first position is represented as ((20, 30), (30, 50)), the size of the first extended screen component is 2 cm in width and 2 cm in length, and the relative positional relationship with the user device is that the first extended screen component is located in the first row and first column at the top of the user device. Then, the coordinates of the top-left corner point of the first extended screen component can be obtained as (20, 28), and the coordinates of the bottom-right corner point can be obtained as (22, 32). The position coordinates of the first extended screen component can be represented as T1 (20,28), (22,32).

The screen size of the user device is known and can be obtained through measurement or by querying the product information of the user device. The size of each extended screen component can be set by the user or be preset by the developer.

The position of each extended screen component is represented as:
T1ₓ_{₁}_{y}_{₁}ₓ_{₂}_{y}_{₂}, T2ₓ_{₁}_{y}_{₁}ₓ_{₂}_{y}_{₂}, . . . , Tnₓ_{₁}_{y}_{₁}ₓ_{₂}_{y}_{₂}, . . .

x₁y₁ represents the coordinates of the top-left corner point of each extended screen component, x₂y₂ represents the coordinates of the bottom-right corner point of each extended screen component, and T1, T2, . . . , Tn are configured to represent the position points of the 1st, 2nd, . . . nth extended screen components. That is, the position of the extended screen component is represented by the coordinates of the top-left corner point and bottom-right corner point of the extended screen component.

In one embodiment, based on the obtained position of each extended screen component in the display interface and the first position of the screen outline of the user device in the display interface, the each extended screen component is displayed around the screen of the user device. For example, as shown in FIG. 2, the each extended screen component is distributed on the left and right sides and the top of the screen of the user device.

S103: Based on a preset algorithm, track the coordinates of a first key point and the coordinates of a second key point of a user's hand in the display interface to generate a movement selection pointer.

Based on a preset algorithm, tracking the coordinates of a first key point and the coordinates of a second key point of the user's hand in the display interface to generate a movement selection pointer includes: identifying the user's hand based on the preset algorithm, and determining the first key point and the second key point; when the movement of the user's hand is detected, tracking first key point coordinates of the first key point and second key point coordinates of the second key point in the display interface; and obtaining a line segment passing through the first key point coordinates and the second key point coordinates as the movement selection pointer, where a direction of the movement selection pointer is from the first key point to the second key point.

In one embodiment, the preset algorithm is a hand key point algorithm, which can track the coordinates of hand key points in real time according to the movement of the user's hand. For example, a hand key point detection method based on MediaPipe (MediaPipe is a framework for building cross-platform machine learning solutions) includes a palm detector and a hand coordinate model. The palm detector is configured to determine the position of the user's hand, and the hand coordinate model is configured to obtain the coordinates of the hand key points. When a human hand is detected, the coordinates of the key points of the human hand can be tracked in real time as the human hand moves.

In a specific embodiment, the preset algorithm is stored in the smart wearable device. When in the screen extension mode, the smart wearable device invokes the preset algorithm to identify 21 key points of the hand, and determines the first key point and the second key point from the key points. For example, a first joint of a thumb of the user is used as the first key point, and a tip of the thumb of the user is used as the second key point.

In one embodiment, the movement of the user's hand causes the coordinates of the first key point and the coordinates of the second key point to change. When changes in the first key point coordinates and the second key point coordinates are detected, it can be determined that the user's hand is moving.

In one embodiment, when the user's hand moves, the first key point coordinates corresponding to the first key point of the user's hand and the second key point coordinates corresponding to the second key point of the user's hand are tracked in real time via the preset algorithm, and the line segment passing through the first key point coordinates and the second key point coordinates is used as the movement selection pointer.

In one embodiment, the direction of the movement selection pointer points from the first key point to the second key point. For example, a line segment starting from the first joint of the thumb and connecting to the tip of the thumb is the movement selection pointer, and a direction from the first joint of the thumb to the tip is the direction of the movement selection pointer.

S104: When the movement of the user's hand is detected, determine the extended screen component that intersects with the movement selection pointer as a target component, so as to control the target component.

After when the movement of the user's hand is detected, determining the extended screen component that intersects with the movement selection pointer as a target component, the method further includes: identifying an operation action of the user's hand, and displaying a corresponding interface of the target component to the user based on the operation action.

The displaying a corresponding interface of the target component to the user based on the operation action includes: identifying the operation action, comparing the operation action with gesture actions in a preset gesture library, and determining an operation instruction corresponding to the operation action; when the operation instruction is detail page display, displaying a details page of the target component; when the operation instruction is component switching, switching the target component based on a preset component switching sequence; and when the operation instruction is to return to the display interface, exiting the details page and returning to the display interface.

In one embodiment, when the user's hand moves, the movement selection pointer changes accordingly. For example, when the user changes a direction of the thumb, the direction of the movement selection pointer generated based on the thumb of the user changes accordingly. During the movement process, the movement selection pointer intersects with the extended screen component around the screen of the user device in the display interface, and the extended screen component that intersects with the movement selection pointer is used as the target component.

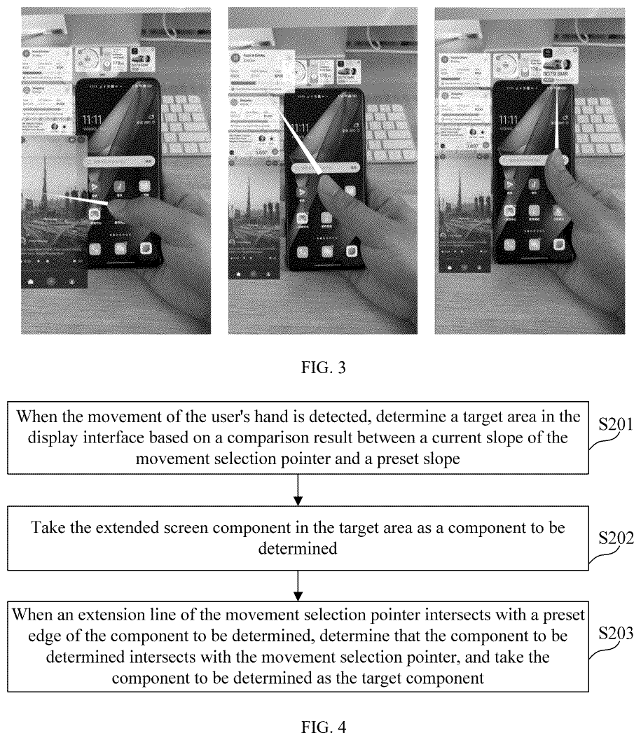

In one embodiment, after the target component is determined, a corresponding display instruction is generated based on a preset component selection display effect, so as to perform component adaptive changes on the target component, such as changes in component size and transparency. As shown in FIG. 3, after the target component is selected, the target component becomes larger to achieve a similar floating effect. At the same time, the transparency of other unselected components increases to highlight the target component.

In one embodiment, after the target component is determined, the operation action of the user's hand is identified, and the operation action of the user's hand is compared with gesture actions in a preset gesture library. The gesture library includes gesture actions and operation instructions corresponding to the gesture actions. After determining the gesture action corresponding to the operation action, the corresponding operation instruction can be obtained. The operation instructions include displaying a details page, switching components, returning to a home interface (i.e., the display interface), etc. The switching components can be switched according to a preset component switching sequence.

The above embodiments provide a method and apparatus for controlling an extended screen component, a computer device, and a storage medium. The method includes: identifying a screen outline of a user device to activate a screen extension mode; based on a relative positional relationship between each extended screen component and the screen outline, displaying the extended screen component and a screen of the user device in a display interface; based on a preset algorithm, tracking the coordinates of a first key point and the coordinates of a second key point of a user's hand in the display interface to generate a movement selection pointer; and when detecting movement of the user's hand, determine the extended screen component that intersects with the movement selection pointer as a target component, so as to control the target component. The method obtains a movement selection pointer based on two key points of the user's hand, and then obtains the intersection between the movement selection pointer and the extended screen component when the user moves the hand, and takes the extended screen component that intersects with the movement selection pointer as a target component, which simplifies user operations and improves the portability and accuracy of the user's selection of the extended screen component.

Referring to FIG. 4, FIG. 4 is a schematic flow chart illustrating a second embodiment of a method for controlling an extended screen component according to an embodiment of the present disclosure. The method for controlling the extended screen component can be applied to a server, and is configured to generate a movement selection pointer through hand key points to further determine a target component, resulting in improving the portability and accuracy of the user's selection of the extended screen component.

As shown in FIG. 4, the step S104 of the method for controlling the extended screen component specifically includes steps S201 to S203.
S201: When the movement of the user's hand is detected, determine a target area in the display interface based on a comparison result between a current slope of the movement selection pointer and a preset slope.
S202: Take the extended screen component in the target area as a component to be determined.
S203: When an extension line of the movement selection pointer intersects with a preset edge of the component to be determined, determine that the component to be determined intersects with the movement selection pointer, and take the component to be determined as the target component.

Before the determining a target area in the display interface based on a comparison result between a current slope of the movement selection pointer and a preset slope, the method further includes: obtaining the current slope of the movement selection pointer based on the first key point coordinates and the second key point coordinates; obtaining coordinate information of the display interface based on size information of the display interface acquired by an image acquisition module; determining a top-left corner point and a bottom-right corner point of the display interface based on the coordinate information; and obtaining a slope of a line segment passing through the top-left corner point and the bottom-right corner point as the preset slope.

In a specific embodiment, the display interface is an interface displayed by the smart wearable device for the user to view, and is acquired by the image acquisition module of the smart wearable device. It can be understood that, when the image acquired by the image acquisition module is not cropped, a size of the image acquired by the image acquisition module is the same as a size of the display interface. The size information of the display interface can be obtained based on size information of the image acquired by the image acquisition module, and a coordinate system can be determined based on size information of the image acquired by the image acquisition module. For example, when the image acquisition module is a camera device, when the width of the image acquired by the camera is known as c_{w} and the height is known as cₕ, the top-left corner point is used as the origin (0, 0) of the coordinate system, a left edge of the display interface is used as a vertical coordinate axis of the coordinate system, and a top edge of the display interface is used as a horizontal coordinate axis, then the coordinates of the bottom-right corner point of the display interface can be obtained as (c_{w}, cₕ), and the slope of the line segment formed by the top-left corner point and the bottom-right corner point is cₖ, which is used as the preset slope.

In a specific embodiment, the first key point coordinates are set to t₁, and the second key point coordinates are set to t₂. The current slope tₖ of the movement selection pointer can be obtained based on the two coordinate points t₁ and t₂.

In one embodiment, by comparing the current slope tₖ of the movement selection pointer with the preset slope cₖ, an area where the target component is located can be preliminarily determined, and the area is used as the target area. All extended screen components in the target area are used as components to be determined for whether they intersect with the extension line of the movement selection pointer.

In a specific embodiment, when tₖ<cₖ, a line segment t₂t₁ is extended to a left edge x=0 of the display interface to obtain an intersection point x₀ with a left edge of the display interface, and a line segment passing through t₂, t₁, and x₀ is obtained. That is, an extension line of the movement selection pointer will pass through a left-side area of the user device and intersect with a preset edge of a certain extended screen component in the left-side area of the user device. At this time, the left-side area is used as the target area. As shown in a first diagram in FIG. 3, the current slope tₖ of the movement selection pointer is less than the slope cₖ of the display interface (i.e., the preset slope), and the extension line of the movement selection pointer will intersect with one of the extended screen components in the left-side area of the user device's screen within the display interface, so the left-side area is used as the target area, and all extended screen components in the left-side area are used as components to be determined.

In one embodiment, when tₖ>cₖ, a line segment t₂t₁ is extended to a top edge y=0 of the display interface to obtain an intersection point y₀ with a top edge of the display interface, and a line segment passing through t₂, t₁, and y₀ is obtained. That is, an extension line of the movement selection pointer will pass through a top area of the user device and intersect with a preset edge of a certain extended screen component in the top area of the user device. At this time, the top area is used as the target area. As shown in a third diagram in FIG. 3, the current slope tₖ of the movement selection pointer is greater than the slope cₖ of the display interface (i.e., the preset slope), and the extension line of the movement selection pointer will intersect with one of the extended screen components in the top area of the user device's screen within the display interface, so the top area is used as the target area, and all extended screen components in the top area are used as components to be determined.

In one embodiment, when tₖ=cₖ, a line segment t₂t₁ is extended to a top-left corner origin (0, 0) to obtain an intersection point t₀ with a top-left corner point of the display interface, and a line segment passing through t₂, t₁, and t₀ is obtained. That is, an extension line of the movement selection pointer will pass through a top-left corner area of the user device and intersect with a preset edge of a certain extended screen component in the top-left corner area of the user device. At this time, the top-left corner area is used as the target area. As shown in a second diagram in FIG. 3, the current slope tₖ of the movement selection pointer is equal to the slope cₖ of the display interface (i.e., the preset slope), and the extension line of the movement selection pointer will intersect with the extended screen component in the top-left corner area of the user device's screen within the display interface, so the top-left corner area is used as the target area, and the extended screen component in the top-left corner area is used as the component to be determined.

In one embodiment, when the user operates with the left hand, the finger direction may point to a right-side area of the user device, and the extension line of the movement selection pointer has a chance to intersect with a preset edge of an extended screen component in the right-side area.

In one embodiment, an edge of the component to be determined that is adjacent to the user device's screen is used as a preset edge. For example, when the left-side area of the user device is determined to be the target area, the extended screen component in the left-side area is used as the component to be determined, and a right border of the component to be determined is used as the preset edge. When the right-side area of the user device is determined to be the target area, the extended screen component in the right-side area is used as the component to be determined, and a left border of the component to be determined is used as the preset edge. When the top area of the user device is determined to be the target area, the extended screen component in the top area is used as the component to be determined, and a bottom border of the component to be determined is used as the preset edge.

When the extension line of the movement selection pointer intersects with the preset edge of the component to be determined, it is determined that the component to be determined intersects with the movement selection pointer, and the component to be determined is used as the target component.

It can be understood that, when determining the target component, the target area where the target component may be located is first determined based on the relationship between the slope of the movement selection pointer and the preset slope, and all extended screen components in the target area are used as components to be determined for whether they are the target component. Then, the edge of the component to be determined that is adjacent to the user device's screen is used as the preset edge, and whether the extension line of the movement selection pointer intersects with the preset edge is determined, so that a single target component can be determined. For example, as shown in the second diagram in FIG. 3, the slope of the movement selection pointer is equal to the preset slope. At this time, the top-left corner area of the user device's screen is used as the target area, and the component in the top-left corner area is used as the component to be determined, and the target component is determined within the component to be determined. Even if the movement selection pointer also intersects with an extended screen component in the left-side area, since the left-side area is not the target area, the extended screen component in the left-side area has been excluded, so the movement selection pointer intersects with the extended screen component in the top-left corner area.

The above embodiments provide a method, apparatus for controlling an extended screen component, a computer device, and a storage medium. The method includes: when the movement of the user's hand is detected, determining a target area in the display interface based on a comparison result between a current slope of the movement selection pointer and a preset slope; taking the extended screen component in the target area as a component to be determined; when an extension line of the movement selection pointer intersects with a preset edge of the component to be determined, determining that the component to be determined intersects with the movement selection pointer, and taking the component to be determined as the target component. By comparing the current slope of the movement selection pointer with the preset slope, the method determines the target area and obtains the extended screen component in the target area as the component to be determined, and by determining whether the preset edge of the component to be determined intersects with the extension line corresponding to the movement selection pointer, the method can accurately determine the extended screen component that intersects with the movement selection pointer as the target component, improving the accuracy of target component determination.

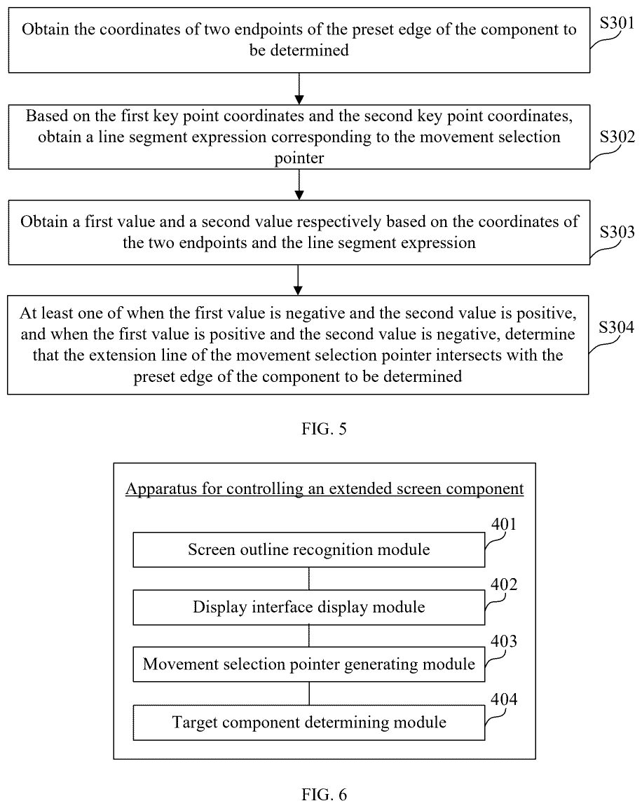

Referring to FIG. 5, FIG. 5 is a schematic flow chart illustrating a third embodiment of a method for controlling an extended screen component according to an embodiment of the present disclosure. The method for controlling the extended screen component can be applied to a server, and is configured to generate a movement selection pointer through hand key points to further determine a target component, resulting in improving the portability and accuracy of the user's selection of the extended screen component.

As shown in FIG. 5, before the determining that the component to be determined intersects with the movement selection pointer when the extension line of the movement selection pointer intersects with the preset edge of the component to be determined, the method further includes steps S301 to S304.
S301: Obtain the coordinates of two endpoints of the preset edge of the component to be determined.
S302: Based on the first key point coordinates and the second key point coordinates, obtain a line segment expression corresponding to the movement selection pointer.
S303: Obtain a first value and a second value respectively based on the coordinates of the two endpoints and the line segment expression.
S304: At least one of when the first value is negative and the second value is positive, and when the first value is positive and the second value is negative, determine that the extension line of the movement selection pointer intersects with the preset edge of the component to be determined.

In a specific embodiment, based on the first key point coordinates t₁ and the second key point coordinates t₂ of the movement selection pointer, and the intersection coordinate x₀, y₀, or t₀ between the extension line of the movement selection pointer and the horizontal/vertical coordinate axis, the line segment expression of the current movement selection pointer can be obtained. For example, assume the line segment expression is y=ax+b, substitute the first key point coordinates t₁, the second key point coordinates t₂, and the intersection coordinate x₀, y₀, or t₀ to calculate the values of a and b, and obtain the line segment expression corresponding to the current movement selection pointer.

In a specific embodiment, the endpoint coordinates of two endpoints of the preset edge are obtained, and the two endpoint coordinates are respectively substituted into an expression w=y−ax−b respectively to obtain the first value w₁ and the second value w₂, and compare the values of w₁ and w₂. When w₁ and w₂ are both positive or both negative, it indicates that the two endpoints of the preset edge are on the same side of the movement selection pointer, that is, the preset edge of the current component to be determined does not intersect with the extension line of the current movement selection pointer. When w₁ is positive and w₂ is negative, or w₁ is negative and w₂ is positive, it indicates that the two endpoints of the preset edge are on opposite sides of the movement selection pointer, that is, the preset edge of the current component to be determined intersects with the extension line of the current movement selection pointer, and thus the component to be determined is determined as the target component. The expression w=y−ax−b is configured to determine whether a certain point is on the same side of the line segment y=ax+b, where the values of a and b are the values in the expression of the current movement selection pointer. Substituting the coordinates (x, y) of the certain point into the expression to obtain the value of w can determine whether the point (x, y) is on the same side of the current line segment y=ax+b. For example, the line segment expression of the current movement selection pointer is y=2x+1, then w=y−2x−1 is obtained. The endpoint coordinates of the preset edge are (2, 1) and (1, 1), when these coordinates are substituted into w=y−2x−1, w₁=−1 and w₂=−2 are obtained. At this time, w₁ and w₂ are both negative, indicating that the endpoints of the preset edge are on the same side of the movement selection pointer, that is, the preset edge will not intersect with the extension line of the movement selection pointer.

The above embodiments provide a control method, apparatus for controlling an extended screen component, a computer device, and a storage medium. The method includes: obtaining the coordinates of two endpoints of the preset edge of the component to be determined; based on the first key point coordinates and the second key point coordinates, obtaining a line segment expression corresponding to the movement selection pointer; obtaining a first value and a second value respectively based on the coordinates of the two endpoints and the line segment expression; and at least one of when the first value is negative and the second value is positive, and when the first value is positive and the second value is negative, determining that the extension line of the movement selection pointer intersects with the preset edge of the component to be determined. By obtaining the coordinates of two endpoints of the preset edge of the component to be determined and the line segment expression corresponding to the movement selection pointer, and by determining whether the two endpoints of the preset edge of the component to be determined are on the same side of the movement selection pointer, the method can accurately determine whether the preset edge of the component to be determined intersects with the extension line of the movement selection pointer, improving the accuracy of target component determination.

Referring to FIG. 6, FIG. 6 is a schematic block diagram illustrating an apparatus for controlling an extended screen component according to an embodiment of the present disclosure. The apparatus for controlling the extended screen component is configured to execute the aforementioned method for controlling the extended screen component. The apparatus for controlling the extended screen component may be configured on a server.

As shown in FIG. 6, the apparatus 400 for controlling the extended screen component includes:
a screen outline recognition module 401, configured to identify a screen outline of a user device to activate a screen extension mode;
a display interface display module 402, configured to, based on a relative positional relationship between each extended screen component and the screen outline, display the extended screen component and a screen of the user device in a display interface;
a movement selection pointer generating module 403, configured to, based on a preset algorithm, track the coordinates of a first key point and the coordinates of a second key point of a user's hand in the display interface to generate a movement selection pointer; and
a target component determining module 404, configured to, when detecting movement of the user's hand, determine the extended screen component that intersects with the movement selection pointer as a target component, so as to control the target component.

In one embodiment, the movement selection pointer generating module 403 includes:
a key point determining unit, configured to identify the user's hand based on the preset algorithm and determine the first key point and the second key point;
a coordinate tracking unit, configured to, when the movement of the user's hand is detected, track first key point coordinates of the first key point and second key point coordinates of the second key point in the display interface; and
a movement selection pointer determining unit, configured to obtain a line segment passing through the first key point coordinates and the second key point coordinates as the movement selection pointer, where a direction of the movement selection pointer is from the first key point to the second key point.

In one embodiment, the target component determining module 404 includes:
a target area determining unit, configured to, when the movement of the user's hand is detected, determine a target area in the display interface based on a comparison result between a current slope of the movement selection pointer and a preset slope;
a component-to-be-determined determining unit, configured to take the extended screen component in the target area as a component to be determined; and
a target component determining unit, configured to, when an extension line of the movement selection pointer intersects with a preset edge of the component to be determined, determine that the component to be determined intersects with the movement selection pointer, and take the component to be determined as the target component.

In one embodiment, the target component determining module further includes a slope acquisition submodule, and the slope acquisition submodule includes:
a current slope acquisition unit, configured to obtain the current slope of the movement selection pointer based on the first key point coordinates and the second key point coordinates;
a coordinate information acquisition unit, configured to obtain coordinate information of the display interface based on size information of the display interface acquired by an image acquisition module; and
a preset slope acquisition unit, configured to determine a top-left corner point and a bottom-right corner point of the display interface based on the coordinate information, and obtain a slope of a line segment passing through the top-left corner point and the bottom-right corner point as the preset slope.

In one embodiment, the target component determining module further includes an intersection determination submodule, and the intersection determination submodule includes:
an endpoint acquisition unit, configured to obtain the coordinates of the two endpoints of the preset edge of the component to be determined;
a line segment expression acquisition unit, configured to, based on the first key point coordinates and the second key point coordinates, obtain a line segment expression corresponding to the movement selection pointer;
a value acquisition unit, configured to obtain a first value and a second value respectively based on the coordinates of the two endpoints and the line segment expression; and
an intersection determining unit, configured to, at least one of when the first value is negative and the second value is positive, and when the first value is positive and the second value is negative, determine that the extension line of the movement selection pointer intersects with the preset edge of the component to be determined.

In one embodiment, the apparatus 400 for controlling the extended screen component further includes a positional relationship acquisition module, and the positional relationship acquisition module includes:
a first position acquisition unit, configured to obtain contour coordinates of the screen outline, and obtain a first position of the user device in the display interface based on the contour coordinates; and
a relative positional relationship acquisition unit, configured to, based on a preset size of each extended screen component, a screen size of the user device and the first position, obtain the relative positional relationship between each extended screen component and the user device.

In one embodiment, the control apparatus 400 for the extended screen component further includes a component display module, and the component display module includes:
a corresponding page display unit, configured to identify an operation action of the user's hand, and display a corresponding interface of the target component to the user based on the operation action.

In one embodiment, the corresponding page display unit includes:
an operation instruction determining subunit, configured to identify the operation action, compare the operation action with gesture actions in a preset gesture library, and determine an operation instruction corresponding to the operation action;
a detail page display subunit, configured to, when the operation instruction is detail page display, display a details page of the target component;
a component switching sub-unit, configured to, when the operation instruction is component switching, switch the target component based on a preset component switching sequence;
a display interface return subunit, configured to, when the operation instruction is to return to the display interface, exit the details page and return to the display interface.

It should be noted that, those skilled in the art will clearly understand that, for the convenience and brevity of description, the specific working processes of the above-described apparatus and each module can refer to the corresponding processes in the aforementioned method embodiments and will not be repeated here.

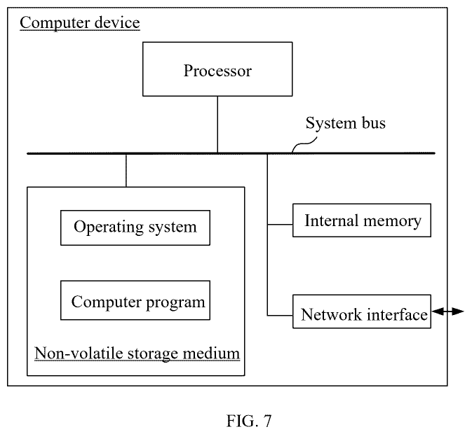

The above-described apparatus may be implemented in the form of a computer program, and the computer program may run on a computer device as shown in FIG. 7.

Referring to FIG. 7, FIG. 7 is a schematic structural block diagram illustrating a computer device according to an embodiment of the present disclosure.

Referring to FIG. 7, the computer device includes a processor, a memory, and a network interface connected via a system bus, where the memory may include a non-volatile storage medium and an internal memory.

The non-volatile storage medium may store an operating system and a computer program. The computer program includes program instructions, and when the program instructions are executed, the processor can be caused to perform any method for controlling an extended screen component.

The processor is configured to provide computing and control capabilities to support the operation of the entire computer device.

The internal memory provides an environment for the operation of the computer program in the non-volatile storage medium. When the computer program is executed by the processor, the processor can be caused to perform any method for controlling an extended screen component.

The network interface is configured for network communication, such as sending assigned tasks. Those skilled in the art will understand that the structure shown in FIG. 7 is a block diagram of a part of the structure related to the solution of the present disclosure, and does not constitute a limitation on the computer device to which the solution of the present disclosure is applied. The specific computer device may include more or fewer components than those shown in the figure, or combine certain components, or have a different component arrangement.

It should be understood that the processor may be a Central Processing Unit (CPU). The processor may also be other general-purpose processors, Digital Signal Processors (DSP), Application Specific Integrated Circuits (ASIC), Field-Programmable Gate Arrays (FPGA) or other programmable logic devices, discrete gate or transistor logic devices, discrete hardware components, etc. The general-purpose processor may be a microprocessor or any conventional processor.

In one embodiment, the processor is configured to execute the computer program stored in the memory to perform the following steps:
identify a screen outline of a user device to activate a screen extension mode;
based on a relative positional relationship between each extended screen component and the screen outline, display the extended screen component and a screen of the user device in a display interface;
based on a preset algorithm, track the coordinates of a first key point and the coordinates of a second key point of a user's hand in the display interface to generate a movement selection pointer; and
when detecting movement of the user's hand, determine the extended screen component that intersects with the movement selection pointer as a target component, so as to control the target component.

In one embodiment, when the processor performs tracking, based on the preset algorithm, the coordinates of the first key point and the coordinates of the second key point of the user's hand in the display interface to generate the movement selection pointer, the processor is configured to perform the following:
identify the user's hand based on the preset algorithm, and determine the first key point and the second key point;
when the movement of the user's hand is detected, track first key point coordinates of the first key point and second key point coordinates of the second key point in the display interface; and
obtain a line segment passing through the first key point coordinates and the second key point coordinates as the movement selection pointer, where a direction of the movement selection pointer is from the first key point to the second key point.

In one embodiment, when the processor performs when detecting movement of the user's hand, determining the extended screen component that intersects with the movement selection pointer as the target component, the processor is configured to perform the following:
when the movement of the user's hand is detected, determine a target area in the display interface based on a comparison result between a current slope of the movement selection pointer and a preset slope;
take the extended screen component in the target area as a component to be determined; and
when an extension line of the movement selection pointer intersects with a preset edge of the component to be determined, determine that the component to be determined intersects with the movement selection pointer, and take the component to be determined as the target component.

In one embodiment, before the processor performs determining the target area in the display interface based on the comparison result between the current slope of the movement selection pointer and the preset slope, the processor is further configured to perform the following:
obtain the current slope of the movement selection pointer based on the first key point coordinates and the second key point coordinates;
obtain coordinate information of the display interface based on size information of the display interface acquired by an image acquisition module;
determine a top-left corner point and a bottom-right corner point of the display interface based on the coordinate information; and obtain a slope of a line segment passing through the top-left corner point and the bottom-right corner point as the preset slope.

In one embodiment, before the processor performs when the extension line of the movement selection pointer intersects with the preset edge of the component to be determined, determining that the component to be determined intersects with the movement selection pointer, the processor is further configured to perform the following:
obtain the coordinates of two endpoints of the preset edge of the component to be determined;
based on the first key point coordinates and the second key point coordinates, obtain a line segment expression corresponding to the movement selection pointer;
obtain a first value and a second value respectively based on the coordinates of the two endpoints and the line segment expression; and
at least one of when the first value is negative and the second value is positive, and when the first value is positive and the second value is negative, determine that the extension line of the movement selection pointer intersects with the preset edge of the component to be determined.

In one embodiment, before the processor performs displaying, based on a relative positional relationship between each extended screen component and the screen outline, the extended screen component and a screen of the user device in a display interface, the processor is further configured to perform the following:
obtain contour coordinates of the screen outline, and obtain a first position of the user device in the display interface based on the contour coordinates; and
based on a preset size of each extended screen component, a screen size of the user device and the first position, obtain the relative positional relationship between each extended screen component and the user device.

In one embodiment, after the processor performs when the movement of the user's hand is detected, determining the extended screen component that intersects with the movement selection pointer as the target component, the processor is further configured to perform the following:
identify an operation action of the user's hand, and display a corresponding interface of the target component to the user based on the operation action.

In one embodiment, when the processor performs displaying the corresponding interface of the target component to the user based on the operation action, the processor is configured to perform the following:
identify the operation action, compare the operation action with gesture actions in a preset gesture library, and determine an operation instruction corresponding to the operation action;
when the operation instruction is detail page display, display a details page of the target component;
when the operation instruction is component switching, switch the target component based on a preset component switching sequence; and
when the operation instruction is to return to the display interface, exit the details page and return to the display interface.

A non-transitory computer-readable storage medium is also provided in an embodiment of the present disclosure, where the non-transitory computer-readable storage medium stores a computer program, the computer program includes program instructions, and the processor executes the program instructions to perform any method for controlling an extended screen component provided in the embodiments of the present disclosure.

The non-transitory computer-readable storage medium may be an internal storage unit of the computer device described in the aforementioned embodiments, such as a hard disk or a memory of the computer device. The non-transitory computer-readable storage medium may also be an external storage device of the computer device, such as a plug-in hard disk, a Smart Media Card (SMC), a Secure Digital (SD) card, a Flash Card, etc., configured on the computer device.

The above description is specific implementations of the present disclosure, but the protection scope of the present disclosure is not limited to the specific implementations of the present disclosure. Any person skilled in the technical field can easily think of various equivalent modifications or substitutions within the technical scope disclosed in the present disclosure, and these modifications or substitutions shall be included within the protection scope of the present disclosure. Thus, the protection scope of the present disclosure should be based on the protection scope of the claims.

What is claimed is:

1. A method for controlling an extended screen component, comprising:
identifying a screen outline of a user device to activate a screen extension mode;
based on a relative positional relationship between each extended screen component and the screen outline, displaying the extended screen component and a screen of the user device in a display interface;
based on a preset algorithm, tracking the coordinates of a first key point and the coordinates of a second key point of a user's hand in the display interface to generate a movement selection pointer; and
when the movement of the user's hand is detected, determining the extended screen component that intersects with the movement selection pointer as a target component, so as to control the target component.

2. The method for controlling the extended screen component according to claim 1, wherein based on a preset algorithm, tracking the coordinates of a first key point and the coordinates of a second key point of the user's hand in the display interface to generate a movement selection pointer comprises:
identifying the user's hand based on the preset algorithm, and determining the first key point and the second key point;
when the movement of the user's hand is detected, tracking first key point coordinates of the first key point and second key point coordinates of the second key point in the display interface; and
obtaining a line segment passing through the first key point coordinates and the second key point coordinates as the movement selection pointer, wherein a direction of the movement selection pointer is from the first key point to the second key point.

3. The method for controlling the extended screen component according to claim 2, wherein the first key point comprises a first joint of a thumb, the second key point comprises a tip of the thumb, and a direction of the movement selection pointer comprises a direction from the first joint of the thumb to the tip of the thumb.

4. The method for controlling the extended screen component according to claim 1, wherein when the movement of the user's hand is detected, determining the extended screen component that intersects with the movement selection pointer as the target component comprises:
when the movement of the user's hand is detected, determining a target area in the display interface based on a comparison result between a current slope of the movement selection pointer and a preset slope;
taking the extended screen component in the target area as a component to be determined; and
when an extension line of the movement selection pointer intersects with a preset edge of the component to be determined, determining that the component to be determined intersects with the movement selection pointer, and taking the component to be determined as the target component.

5. The method for controlling the extended screen component according to claim 4, wherein determining the target area in the display interface based on the comparison result between the current slope of the movement selection pointer and the preset slope comprises:
when the comparison result indicates that the current slope is less than the preset slope, determining a first area in the display interface as the target area, wherein the first area comprises a left-side area of the user device.

6. The method for controlling the extended screen component according to claim 5, wherein before when the extension line of the movement selection pointer intersects with the preset edge of the component to be determined, determining that the component to be determined intersects with the movement selection pointer, and taking the component to be determined as the target component, the method further comprises:
extending the movement selection pointer along its direction until it intersects with a left edge of the display interface, so as to obtain the extension line; and
determining a right border of the component to be determined as the preset edge.

7. The method for controlling the extended screen component according to claim 4, wherein determining the target area in the display interface based on the comparison result between the current slope of the movement selection pointer and the preset slope further comprises:
when the comparison result indicates that the current slope is greater than the preset slope, determining a second area in the display interface as the target area, wherein the second area comprises a top area of the user device.

8. The method for controlling the extended screen component according to claim 7, wherein before when the extension line of the movement selection pointer intersects with the preset edge of the component to be determined, determining that the component to be determined intersects with the movement selection pointer, and taking the component to be determined as the target component, the method further comprises:
extending the movement selection pointer along its direction until it intersects with a top edge of the display interface, so as to obtain the extension line; and
taking a bottom border of the component to be determined as the preset edge.

9. The method for controlling the extended screen component according to claim 4, wherein determining the target area in the display interface based on the comparison result between the current slope of the movement selection pointer and the preset slope further comprises:
when the comparison result indicates that the current slope is equal to the preset slope, determining a third area in the display interface as the target area, wherein the third area comprises a top-left corner area of the user device.

10. The method for controlling the extended screen component according to claim 9, wherein before when the extension line of the movement selection pointer intersects with the preset edge of the component to be determined, determining that the component to be determined intersects with the movement selection pointer, and taking the component to be determined as the target component, the method further comprises:
extending the movement selection pointer along its direction until it intersects with a top-left corner point of the display interface, so as to obtain the extension line; and
taking a bottom border and a right border of the component to be determined as the preset edges.

11. The method for controlling the extended screen component according to claim 4, wherein before determining the target area in the display interface based on the comparison result between the current slope of the movement selection pointer and the preset slope, the method further comprises:
obtaining the current slope of the movement selection pointer based on the first key point coordinates and the second key point coordinates;
obtaining coordinate information of the display interface based on size information of the display interface acquired by an image acquisition module; and
determining a top-left corner point and a bottom-right corner point of the display interface based on the coordinate information; and obtaining a slope of a line segment passing through the top-left corner point and the bottom-right corner point as the preset slope.

12. The method for controlling the extended screen component according to claim 4, wherein before determining the target area in the display interface based on the comparison result between the current slope of the movement selection pointer and the preset slope, the method further comprises:
obtaining the coordinates of two endpoints of the preset edge of the component to be determined;
based on the first key point coordinates and the second key point coordinates, obtaining a line segment expression corresponding to the movement selection pointer;
obtaining a first value and a second value respectively based on the coordinates of the two endpoints and the line segment expression; and
at least one of when the first value is negative and the second value is positive, and when the first value is positive and the second value is negative, determining that the extension line of the movement selection pointer intersects with the preset edge of the component to be determined.

13. The method for controlling the extended screen component according to claim 1, wherein before displaying, based on the relative positional relationship between each extended screen component and the screen outline, the extended screen component and a screen of the user device in a display interface, the method further comprises:
obtaining contour coordinates of the screen outline, and obtaining a first position of the user device in the display interface based on the contour coordinates; and
based on a preset size of each extended screen component, a screen size of the user device and the first position, obtaining the relative positional relationship between each extended screen component and the user device.

14. The method for controlling the extended screen component according to claim 1, wherein after when the movement of the user's hand is detected, determining the extended screen component that intersects with the movement selection pointer as a target component, the method further comprises:
identifying an operation action of the user's hand, and displaying a corresponding interface of the target component to the user based on the operation action.

15. The method for controlling the extended screen component according to claim 14, wherein displaying the corresponding interface of the target component to the user based on the operation action comprises:
identifying the operation action, comparing the operation action with gesture actions in a preset gesture library, and determining an operation instruction corresponding to the operation action;
when the operation instruction is detail page display, displaying a details page of the target component;
when the operation instruction is component switching, switching the target component based on a preset component switching sequence; and
when the operation instruction is to return to the display interface, exiting the details page and returning to the display interface.

16. The method for controlling the extended screen component according to claim 1, wherein based on the relative positional relationship between each extended screen component and the screen outline, displaying the extended screen component and the screen of the user device in a display interface comprises:
based on the relative positional relationship among a first position of the user device in the display interface, a size of each extended screen component, and a user position, obtaining a position of each extended screen component in the display interface; and
based on the position of each extended screen component in the display interface and the first position, displaying the extended screen component and the screen of the user device in the display interface.

17. The method for controlling the extended screen component according to claim 1, wherein after when the movement of the user's hand is detected, determining the extended screen component that intersects with the movement selection pointer as a target component, the method further comprises:
based on a preset component selection display effect, generating a display instruction corresponding to the preset component selection effect; and
based on the display instruction, controlling the target component to perform display changes.

18. The method for controlling the extended screen component according to claim 2, wherein after when the movement of the user's hand is detected, determining the extended screen component that intersects with the movement selection pointer as a target component, the method further comprises:
based on a preset component selection display effect, generating a display instruction corresponding to the preset component selection effect; and
based on the display instruction, controlling the target component to perform display changes.

19. A computer device, comprising a memory and a processor; wherein the memory is configured to store a computer program; the processor is configured to execute the computer program, and perform a method for controlling the extended screen component; wherein the method comprises:
identifying a screen outline of a user device to activate a screen extension mode;
based on a relative positional relationship between each extended screen component and the screen outline, displaying the extended screen component and a screen of the user device in a display interface;
based on a preset algorithm, tracking the coordinates of a first key point and the coordinates of a second key point of a user's hand in the display interface to generate a movement selection pointer; and
when the movement of the user's hand is detected, determining the extended screen component that intersects with the movement selection pointer as a target component, so as to control the target component.

20. A non-transitory computer-readable storage medium storing a computer program that, when executed by a processor, causes the processor to perform a method for controlling an extended screen component; wherein the method comprises:
identifying a screen outline of a user device to activate a screen extension mode;
based on a relative positional relationship between each extended screen component and the screen outline, displaying the extended screen component and a screen of the user device in a display interface;
based on a preset algorithm, tracking the coordinates of a first key point and the coordinates of a second key point of a user's hand in the display interface to generate a movement selection pointer; and
when the movement of the user's hand is detected, determining the extended screen component that intersects with the movement selection pointer as a target component, so as to control the target component.
